(19) United States
(12) Patent Application Publication
(10) Pub. No.: US 2016/0280847 A1
(43) Pub. Date: Sep. 29, 2016

(54) Novel Polyester Suitable for Producing Carrier Materials for Adhesive Tapes

(71) Applicant: TESA SE, Norderstedt (DE)

(72) Inventors: Bernhard Müssig, Seevetal (DE); Ingo Neubert, Norderstedt (DE); Michael Siebert, Schenefeld (DE)

(21) Appl. No.: 15/035,833

(22) PCT Filed: Nov. 17, 2014
(86) PCT No.: PCT/EP2014/074707

§ 371 Date: May 11, 2016

(30) Foreign Application Priority Data
Nov. 18, 2013 (DE) 102013223496.1

(51) Int. Cl. C08G 63/16; C09J 7/02; C09J 7/04

(52) U.S. Cl. CPC C08G 63/16; C09J 7/04; C09J 7/0235; C09J 2203/302; C09J 2400/263; C09J 2467/006; C09J 2467/005

(57) ABSTRACT

The invention relates to bio-based polymer based on at least two different bio-based monomers obtained from biomass-containing carbohydrates, wherein at least one bio-based monomer is a furan derivative according to formula (I). In each case, independently of one another, R1 is a hydrogen or an organofunctional group with 1 to 20 C atoms and optionally, the organofunctional group contains O, N, or S atoms; R2 is an organofunctional group with 1 to 20 C atoms, which optionally contains O, N, or S atoms, the second bio-based monomer is a hydroxyl-functional compound comprising from 1 to 100 C atoms. The polymer has an average molecular weight Mw greater than or equal to 1,000 g/mol, and the proportion of bio-based monomers in the bio-based polymer is greater than or equal to 55 mol-% with respect to all monomers of the polymer.

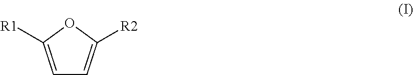

The present invention relates to a biobased polymer based on two or more different biobased monomers derived from biomass comprising carbohydrates where the at least one biobased monomer is a furan derivative, preferably an ester type furan derivative, suitable for forming a biobased polyester. The second biobased monomer is a hydroxyl-functional compound, preferably an alpha,omega-dihydroxyl-functional compound. The biobased polyester of the present invention is useful in the manufacture of carrier materials, especially in the manufacture of carriers for adhesive tapes. The biological origin of a biomass or regenerative raw material is verifiable by determining the ratio of ¹⁴C/¹³C atoms in the polymer or in the particular monomers.

Adhesive tapes have long been used in industry to wrap cable looms. A multiplicity of electrical wires before or after installation are bundled together using the adhesive tapes in order to reduce the space requirements of the wire bundle by bandaging and also to additionally achieve protective functions.

Adhesive tapes for cable sheathing are tested and classified in the automotive industry according to extensive sets of standards, for example LV 312-1 “Protective Systems for Wire Harnesses in Motor Vehicles, Adhesive Tapes; Test Guideline” (10/2009) as jointly operated Daimler, Audi, BMW and Volkswagen. Hereinbelow this standard will be referred to in short as LV 312.

The noise-dampening, abrasion resistance and thermal stability properties of an adhesive tape are determined using defined test setups and procedures as described at length in LV 312.

Cable wrapping tapes are widely used with film and textile carriers, invariably coated on one side with various pressure-sensitive adhesives, and have to meet three principal requirements:
a) Ease of unwind: The product, presented in roll form, has to be easy to unwind for convenient processing.
b) Flagging resistance: Flagging—in the case of an adhesive tape wound around some structure—is to be understood as meaning the tendency of one end of the adhesive tape to stick up. The cause is a combination of the adhesive's holding power, the stiffness of the carrier and the diameter of the cable loom. In commercial use, ends of adhesive tapes must not detach automatically.
c) Cable compatibility: The cable insulation must not become brittle as a result of the influence of the adhesive tape in combination with elevated temperature over a prolonged period. A distinction is made here, in accordance with LV 312, between four temperature classes A to D, corresponding to 80° C. (also referred to as temperature class A), 105° C. (also referred to as temperature class B), 125° C. (also referred to as temperature class C) and 150° C. (also referred to as temperature class D), which the wrapped cables are required to withstand for 3000 hours without embrittling, higher demands being imposed on the adhesive tape by temperature classes C and D than lower classes A and B. The classification into A to D is decided not only by the cable insulation material but also by the pressure-sensitive adhesive and the carrier type.

Useful carrier types for the purposes of the present invention include particularly textile carriers, including foils, nonwovens, foams, wovens and combinations of these types of carriers. Starting materials hitherto used for producing a carrier are polymers, in particular synthetic polymers comprising polyester, polypropylene, polyamide, polyimide, aramid, polyolefin such as high or low density polyethylenes, nylon, polyvinyl alcohols and polyacrylonitriles or glass.

US 2011/0256397 A1 contains further examples of synthetic polymeric materials which are used in nanofibers, films, nonwovens and wovens and include polystyrene, polycarbonates, polyacrylic acid, polymethyl acrylate, polyvinyl chloride, polyethylene terephthalate, polyurethane, polylactic acid, polycaprolactone, polyethylene glycol, polyvinyl acetate and polyethylene oxide in addition to those already mentioned.

Polymers having ester groups in the main chain are most widely used. Preference among these synthetic polyesters is given to the thermoplastic polyethylene terephthalate (PET), which is used particularly in the textile industry and also the packaging industry. The requirements on the material in terms of processability, appearance (transparency), thermal sensitivity/stability, perviousness, permeability, odor neutrality, flexibility/sturdiness differ according to use.

Polyester has hitherto been the preferred choice of material for carriers of adhesive tapes (JP 2004 024 958 A, JP 2001 003 019 A, U.S. Pat. No. 6,063,492 B and EP 0 821 044 A2). The polyester used as preferred starting material is PET by virtue of its core properties, particularly by virtue of its comparatively high hardness, strength, stiffness, abrasion resistance, weathering and hot air resistance and low water imbibition. Owing to the use of PET for adhesive tapes, such adhesive tapes have the disadvantage of high stiffness.

Copolymers, for example, have hitherto been used to achieve the flexibility required of a carrier for adhesive tapes. US 2007/0261879 A1 describes using a copolymer from polypropylene and polyolefin to achieve adequate flexibility for wrapping foils used for bundling, protecting, identifying, insulating and sealing wires and cables and in cable sheathing.

The starting materials that are used for forming polymers derive from nonregenerative raw materials, are produced synthetically and are not biodegradable.

Rising environmental awareness and also the reduced availability of fossil raw materials increase the need for biodegradable and regenerative materials. Particularly such materials that in terms of functionality and quality are fully the equal of synthetic materials.

Polymers have already been described in some publications as partially compostable/biodegradable and formed from regenerative raw materials. As the printed publications (JP 2008 303 488 A, JP 2005 023 484 A, U.S. Pat. No. 5,525,409) reveal, the biodegradable polymers are mostly aliphatic polyesters such as polylactic acid, which are used in the manufacture of biodegradable plastics articles such as clothing, materials in the sanitary sector and medical/medicinal sector, packaging material and for textiles for adhesive tapes (JP 2208385 A). There have also been endeavors to modify the synthetic PET via biobased building blocks. EP 1 140 231 B1, for instance, describes a biodegradable copolymer comprising PET and polyhydroxyalkanoate useful in the manufacture of plastic articles such as fibers, foam, nonwovens, elastomers, adhesives and sheetlike structures.

Yet there continues to be a need for biobased polymers, in particular biobased polyesters, having properties required of a carrier for an adhesive tape that are comparable to those of PET.

It is known that approximately 200 trillion metric tons of biomass are produced per year, 95% of which is in the form of carbohydrates. Hitherto, however, only 3 to 4% of the carbohydrates are re-used. As a result, enormous amounts of untapped sources of starting materials are produced every year. There is accordingly a considerable need and an enormous potential for tapping the biomass as a source for the production of non-petroleum based chemicals that are fully regenerative. Regenerative raw materials based on wood, straw, stalks, reed, hulls of food such as rice hulls and also further remnants of crop plants or remnants of food production plants are said to be advantageous.

Extensive endeavors are accordingly underway to derive starting materials from biomass that are useful in the manufacture of alternative compounds for the synthesis of polymers, in particular polyesters. Such a building block is furan-2,5-dicarboxylic acid (FDCA), described in DE 10 95 281 A way back in 1960.

US 2009/124829 A describes a terephthalic acid and a process for producing same from furan-2,5-dicarboxylic acid wherein the furan-2,5-dicarboxylic acid is derived as a regenerative starting material from biomass comprising plants, cereal, energy crops, lignocellulose (wood), waste streams, paper waste and agricultural waste. The furan-2,5-dicarboxylic acid is therein by enzymatic or microbial degradation of the carbohydrates via sugars and these subsequently to 5-hydroxymethylfurfural, and the 5-hydroxymethylfurfural is oxidized to furan-2,5-dicarboxylate (FDCA).

Owing to the structural similarity of furan-2,5-dicarboxylic acid (FDCA) and terephthalic acid, FDCA is viewed as an alternative building block for partial or complete replacement in polyesters. Jaroslaw Lewkowski, ARKIVOC 2001 (i), pages 17 to 54, ISSN 1424-6376, entitled “Synthesis, Chemistry and Applications of 5-hydroxymethylfurfural and its derivatives” already contains a comprehensive summary regarding furan-2,5-dicarboxylic acid, its possible uses and also its synthesis. Adapted processes for producing FDCA have been developed on that basis.

Partenheimer et al. describe the synthesis of furan-2,5-dicarboxy acid by air oxidation of 5-hydroxymethylfurfural under catalysis with the metal/bromide catalyst Co/Mn/Br (Adv. Synth. Catal. 2001, 343, pp. 102-1 1).

In addition to furan-2,5-dicarboxylic acid being employed as an alternative to terephthalic acid in PET, furan-2,5-dicarboxylic acid is used as an additive in the production of polymers.

US 2012/202725 A and also US 2012/220507 A and WO 2012/113608 A describe the use of FDCA for preparing an ester mixture, for example pentyl esters, for use as a plasticizer for inter alia adhesives and constituents of adhesives. Further dialkyl esters of furandicarboxylic acid at from 1 to 13 carbon atoms are described in WO 2012/113607 A and are employed as plasticizers. The plasticizers are further described to be used for polymers, PVC for example, in adhesives, sealing materials, coating materials, plastisols, pastes, floor coverings, fabric coatings, cables and wire insulations, foils or automotive interior applications as well as elsewhere. These polymers are employed for the production of foil, where the foil is inter alia a sealing sheet, a cable or wire sheath, a packaging foil, an automotive interior article or a furnishing item.

Furan-2,5-dicarboxylic acid is further used not as a starting material for preparing terephthalic acid, but as a building block of an alternative polyester to PET, namely polyethylene furanoate (PEF), in the food packaging industry. In PEF, the petroleum-based monomer terephthalic acid (TA), which is mainly used for the production of PET, is replaced. The result is the bioplastic PEF (polyethylene furanoate), in which the furanoate is biobased and which is comparable to the raw material PET.

Further possible applications being discussed for polyethylene furanoate include the manufacture of fibers (apparel, carpets, sports goods) and also films (flexible packaging and receptacles for example for food products or cosmetics). However, nothing has been published on this to date. Nor has as yet anything been reported regarding the use of biobased polymers, especially polyesters, for carrier materials that exhibit in combination the functional and qualitative properties associated with the synthetic polyesters hitherto used. The synthetic polyesters used for carrier materials, particularly PET, PC and PVC, all have the disadvantage that they are manufactured from compounds based on petroleum, resulting in high costs and a severe impact on the environment. It is known, however, that biobased ethylene glycol is used for the production of PET known as bio-PET, and potentially can also be used for the production of PEF.

A further disadvantage is that the raw materials from petroleum are based on a finite resource whose extraction is associated with enormous costs. It is incumbent upon the presentday generation to consider its responsibility to the coming generations as well as costs and deal with raw materials in a sustainable manner.

A further disadvantage, particularly with the use of PET, is the high density and hence high stiffness of adhesive tapes, particularly of adhesive tapes for cable bundling.

It is an object of the present invention to provide a biobased polymer for the production of biobased polyesters that is derived from compounds derived from biomass. It is a further object of the present invention to provide a biobased polyester which exhibits in combination functional and qualitative properties comparable to those of synthetic polyesters used in the prior art, or is actually better. It is a further object of the present invention to provide a biobased polyester useful in the manufacture of sheetlike elements and/or fibrous structures, particularly those for production of carrier materials. It is also an object of the present invention to provide biobased carrier materials for adhesive tapes, in particular such adhesive tapes for use in automotive interior applications, preferably of sufficient elasticity and good manual processability. It is a further object of the present invention to provide a process for producing the biobased polyesters and the adhesive tape. It is a primary object to provide a fully biobased PEF based on furanoate and a hydroxyl-functional compound.

The solution to the problem addressed by the present invention is described by the subjects of the independent claims and also set forth in specific form in the dependent claims as well as in detail in the description.

One aspect of the present invention provides a biobased polymer based on two or more different biobased monomers, in particular on monomers based on renewable starting material. Preferably, all the monomers according to the present invention are derived from biomass comprising carbohydrates and thus count as biobased monomers where at least one of the biobased monomers is a furan derivative of formula I,

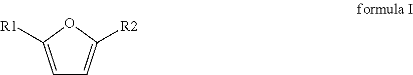

where
R1 is independently a hydrogen or an organofunctional group having 1 to 20 carbon atoms and the organofunctional group optionally contains O, N or S atoms,
R2 is independently an organofunctional group having 1 to 20 carbon atoms which optionally contains O, N or S atoms, the second biobased monomer is a hydroxyl-functional compound comprising 1 to 100 carbon atoms,
wherein the polymer has an average molecular weight Mw of not less than 1000 g/mol and the proportion of biobased monomers in the biobased polymer is not less than 55 mol % relative to the entire biobased polymer or the biobased polymers.

Biobased is to be understood as meaning made from regrowable raw materials. Biodegradable is a term applied to natural and synthetic polymers that have plastic-like properties (notched impact strength, thermoplastifiability) but, in contradistinction to conventional plastics, are degraded by a multiplicity of microorganisms in biologically active surroundings (compost, digested sludge, soil, wastewater); this does not necessarily happen under customary domestic conditions (composting in the garden). A definition of biodegradability is found in the European standards DIN EN 13432 (biodegradation of packaging) and DIN EN 14995 (compostability of plastics).

The proportion of biobased monomers is preferably not less than 60 mol % to 100 mol % relative to the biobased polymer, more preferably not less than 65 mol %, 70 mol %, 75 mol %, 80 mol %, 85 mol %, 90 mol %, yet more preferably the proportion of biobased monomers in the biobased polymer is not less than 95 to 100 mol %. The proportion of biobased monomer in the polymer may be determined by biodegrading the polymer to CO₂ and determining the ratio of ¹⁴C/¹²C atoms. This ratio may then be placed in relation to a ratio of ¹⁴C/¹²C atoms in carbon sources of biological origin (biological origin on the Earth's surface) such as biomass to the ratio of ¹⁴C/¹²C atoms in petroleum-based products. The method of choice is ASTM D6866-04, as more particularly described in the experimental section. Alternatively, the determination as to whether the particular monomer used is biobased or petroleum-based may be carried out prior to polymerization. In this case, the proportion of biobased monomers may simply be determined for example beforehand in the C₆ furandicarboxylic acid or a diester of furandicarboxylic acid and in the ethylene glycol. Monomers from fermented petroleum-based products do not count as biomass.

A further method to determine the origin involves quantifying the isotope pattern, particularly ¹³C isotope pattern, in organic molecules, the biobased monomers or biobased polymer via an isotopomer analysis. Thus, the analysis of ¹³C/¹²C ¹⁵N/¹⁴N and also ³⁴S/³²S ratios is common practice in presentday ecology and may be applied to the biobased polymer of the present invention. Fractionation can be used to track product flows and the provenience of biomass materials, of biobased monomers. A customary method is that of Compound Specific Isotope Analysis (CSIA).

The biobased polymer preferably has linear, cyclic and/or branched chains. The polymer is preferably a co-polymer and at least one tetramer comprising two or more biobased monomers of formula I and two biobased hydroxyl-functional compounds, preferably diols, alpha,-omega-diols or polyhydroxyhydrocarbons, preferably at least one octamer comprising at least four biobased monomers of formula I and four hydroxyl-functional compounds. An advantageous prepolymer is preferably a copolymer comprising at least one biobased monomer of formula I and at least one biobased hydroxyl-functional compound, preferably a diol. In a particular embodiment, the polymer is a copolymer comprising a biobased monomer of formula II and a biobased diol comprising glycol. It is particularly preferable for the copolymer to be a polyethylene furanoate of formula IV where n is not less than 2, preferably where n is not less than 6.

Polymers for the purposes of the invention further are homopolymers or copolymers comprising random, alternating, gradient and block copolymers.

“Biobased” is to be understood for the purposes of the invention as meaning a non-synthetic material of natural origin, while “renewable” is to be understood for the purposes of the invention as meaning renewable. Thus, the invention preferably utilizes starting materials of natural origin that are renewable. Preference is given to using such a biomass having a high energy potential and selected from vegetable origin such as wood, natural fibers, reed, straw, hay, carbohydrates, celluloses, plant oils and also sugars and starch, for example sugar beet. Preference is given to using biogenic waste products such as agricultural wastes and food wastes. The saccharides or carbohydrates in the biomass for the purposes of the invention comprise compounds of the chemical groups polyhydroxyalkanals, -alkanones, -tetrahydrofurans, -tetrahydropyrans, -oxepans and -alkanoic acids. These comprise aldoses, ketoses, ketoaldoses, deoxysugars, aminosugars and derivatives thereof. Preference is given to mono-, di-, oligo- and polysaccharides (including sugars and starch). These compounds may contain glycosidic bonds and be joined together to form double and multiple sugars. Examples of mono-saccharides include, without any limitation being applied, pentoses and hexoses, such as D-xylose, D-ribose, D-glucose, D-mannose, D-galactose, D-rhamnose and D-fructose and also maltose and trehalose. Pentoses and hexoses are preferred sugars.

Furan derivatives for the purposes of the invention comprise compounds of formula I having organofunctional groups. “Organofunctional groups” for the purposes of the invention comprise cyanates, isocyanates, diazo groups, amines, imines, amides, azides, hydrazines, phosphanes, disulfides, hydroxyl, hydroperoxy, hydroxylamines, nitro, nitroso, aldehydes, ketones, peroxides, ethers, esters, esters of aliphatic carboxylic acids (fatty acids), carboxylic acid, acid derivatives comprising anhydrides, esters, amides, hydrazines, imides and amidines. The organofunctional group is preferably in each case a correspondingly substituted hydrocarbon.

The present invention further provides a biobased polymer where preferably R1 is a carboxyl group and by way of substituent contains a linear, branched and/or cyclic substituted or unsubstituted hydrocarbyl group having 1 to 20 carbon atoms, a carboxylic acid group or a carboxylic anhydride group. The hydrocarbyl group is more particularly an alkyl, alkylaryl, alkylene or aryl group or a polyhydroxyhydrocarbon such as sugar, in which case the hydrocarbyl group optionally contains O, N or S atoms, or R1 is a hydrogen and R2 is a carboxyl group and comprehends by way of substituent a linear, branched and/or cyclic substituted or unsubstituted hydrocarbyl group having 1 to 20 carbon atoms, a carboxylic acid group or a carboxylic anhydride group.

The “hydrocarbyl group” for the purposes of the invention corresponds to hydrocarbon compounds, which may be saturated or unsaturated, comprising alkanes, cycloalkanes, alkenes, alkynes and homo- and also heterocyclic aromatics. The alkanes comprise methyl, ethyl, propyl, butyl via decyl through to cosyl groups.

More particularly, the hydrocarbyl groups on R1 and/or R2 may each independently have one or more substituents selected from the group comprising hydrogen, —O, —OH, —CO—OH, an ester such as —CO—OR3, where R3 comprises a group of 1 to 10 carbon atoms, or —(CO)H.

The present invention further provides a biobased polymer which preferably contains one or more biobased monomers of which at least one corresponds to a furan derivative of formula II,

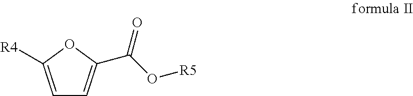

where R4 is selected from the group comprising OH, an organofunctional group of 1 to 20 carbon atoms, particularly a carboxyl group, and by way of substituent a linear, branched and/or cyclic substituted or unsubstituted hydrocarbyl group having 1 to 20 carbon atoms. The hydrocarbyl group may more particularly be an alkyl, alkylaryl, alkylene or aryl group or a polyhydroxyhydrocarbon such as sugar, in which case the hydrocarbyl group optionally contains O, N or S atoms. Preferably, R4 is a —COH or —COR with R as the above-defined hydrocarbyl group. Preferred hydrocarbyl groups on R4 are methyl, ethyl, propyl, butyl and hexyl. R4 is preferably a carboxyester where the ester is derived from dihydroxy compounds, and so in a particular embodiment of the present invention the biobased polymer comprises a monoester derivative of furandicarboxylic acid as a biobased polymer of formula II with the proviso that R5 is hydrogen.

R5 is further selected from the group comprising hydrogen or a linear, branched and/or cyclic substituted or unsubstituted hydrocarbyl group having 1 to 20 carbon atoms. More particularly, the hydrocarbyl group may be an alkyl, alkylaryl, alkylene or aryl group or a polyhydroxyhydrocarbon such as sugar, in which case the hydrocarbyl group may optionally contain O, N or S atoms.

Preferably, R4 is a carboxyester derived from a dihydroxy compound and R5 is a dihydroxy compound. In a further embodiment, the biobased monomers of formula II are dialkyl esters each independently comprising alkyl groups of 1 to 15 carbon atoms, preferably alkyl groups each independently comprising methyl, ethyl, propyl, butyl and hexyl.

The present invention further provides a biobased polymer characterized in that the biobased monomer of formula I and/or formula II is derived from at least one premonomer corresponding to at least one furan derivative of formula III,

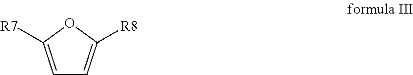

where R7 is selected from the group comprising a linear, branched and/or cyclic substituted or unsubstituted hydrocarbyl group having 1 to 20 carbon atoms, which optionally contains O, N or S atoms, —CO—R9, —(CH₂)ₓ—O—R9, —O—R9 and hydrogen, R8 is selected from the group comprising a linear, branched and/or cyclic substituted or unsubstituted hydrocarbyl group having 1 to 20 carbon atoms, which optionally contains O, N or S atoms, and —CO—R9, —(CH₂)ₓ—O—R9, —O—R9 and hydrogen, where R9 in each case is independently selected from the group comprising a linear, branched and/or cyclic substituted or unsubstituted hydrocarbyl group having 1 to 20 carbon atoms, which optionally contains O, N or S atoms, and hydrogen and x is in each case independently an integer between 1 and 10, preferably not less than 1 to 8, more preferably not less than 1 to 6. The hydrocarbyl group in R7, R8 and R9 may be in each case independently an alkyl, alkylaryl, alkylene or aryl group or a polyhydroxyhydrocarbon such as sugar, in which case the hydrocarbyl group may optionally contain O, N or S atoms.

More particularly, the premonomer may be a furan derivative of formula III such as an alkoxymethylfuran (furan ether R7=—O—R9), preferably a 2,5-bis(alkoxymethyl)furan, or a furfural (furanaldehyde, R—(C═O)H) selected from the group comprising alkoxymethylfurfural, 5-hydroxymethylfurfural (HMF), 2-ethoxymethylfurfural (EMF) and 5-ethoxymethylfurfural (EMF). It is also possible to use mixtures comprising two or more furan derivatives of formula III, preferably two or more of the aforementioned compounds as premonomers to obtain the biobased monomers of formula I and/or formula II.

The problem addressed by the present invention is further solved when the biobased polymer described above is formed by a polymerization, copolymerization, emulsion polymerization, solid state and/or melt state polycondensation, condensation or transesterification, preferably by transesterification of the biobased monomer of formula I, and of a biobased hydroxyl-functional compound such as diol, polyol or monool such as aminoalcohol. The polymer obtained from the reaction is a polyester or polyesteramide.

The polyester is more particularly a polymer having a molecular weight Mw of 500 g/mol to 10 000 g/mol or of 1000 g/mol to 100 000 g/mol, preferably of 5000 g/mol to 100 000 g/mol, of 20 000 to 500 000 g/mol or of 100 000 to 1 000 000 g/mol, more preferably of 1000 to 50 000 g/mol.

The biobased polymer of the present invention is obtainable by reacting the biobased monomer of formula I and a diol in order to obtain a polyester by polycondensation, in which case the diol is preferably an alpha, omega-diol having 1 to 100 carbon atoms, dihydroxycyclohexanediol, dihydroxyaryl, more preferably a 1,2-diol, 1,3-propanediol, 1,4-butanediol, 1,5-pentanediol, 1,6-hexanediol, a fruit acid, a saccharide, a disaccharide, a monosaccharide, a polyhydroxy compound such as a gluconate. The diol is preferably a biobased 1,2-diol.

In the present invention, a biobased polyester is obtainable via a polycondensation, which may correspond to a transesterification, by reacting one or more biobased monomers of formula II, preferably one or more derivatives of furan-2,5-dicarboxylic acid such as esters or anhydrides with a diol, in particular a glycol. The glycol is preferably an ethylene glycol reacted in excess with the monomers of formula I. The ethylene glycol is preferably biobased.

The invention similarly provides biobased polymers comprising polyesters of a monool used as end group and selected from alcohols, aminoalcohols useful for preparing polyester amides, monohydroxy-functional polyethers and/or polyols selected from diols, triols, glycerol, fruit acids, 6-hydroxyhexanecarboxylic acid, saccharides, gluconate, pentaerythritol and polyether polyols comprising 1 to 100 carbon atoms. Monools for the purposes of the invention comprise substituted and unsubstituted monohydric alcohols having 1 to 20 carbon atoms comprising cyclic, linear and/or aromatic systems, in particular phenols and derivatives thereof. Monools are useful for endcapping. A monohydroxy-functional polyether for the purposes of the invention is a polymeric ether having 1 to 100, 3 to 80, preferably 5 to 40, more preferably 5 to 30 carbon atoms and two or more ether groups comprising a hydroxyl group. Preferred polyethers are derived from the respective epoxides and comprise polyethylene glycol, polypropylene glycol and polyhydrofuran, enumerated without any limitation being implied. It is also possible to employ the corresponding polyethers as diols preferably as alpha, omega-diol polyethers. Examples of aminoalcohols include—without limitation—monoethanolamine or to be precise 2-aminoethanol, 2-(2-aminoethoxy)ethanol, 1-amino-2-propanol and 2-amino-2-ethyl-1,3-propanediol. Diols for the purposes of the invention are organic compounds having 2 alcoholic hydroxyl groups, and are subdivided into a) polyethylene glycols comprising alpha, omega-diols such as diethylene glycol, triethylene glycol and polyethylene glycol, b) enediols, c) aldehyde hydrates such as methanediol derived from formaldehyde, and d) dihydroxyaromatics.

The present invention further provides a biobased prepolymer comprising an ester of furan-2,5-dicarboxylic acid comprising mono- and diesters of furan-2,5-dicarboxylic acid and of a diol. Preference is also given to a biobased polymer formed from monomers of formula I and/or formula II such as furan-2,5-dicarboxylic acid, from an anhydride, a monoester and/or a diester of furan-2,5-dicarboxylic acid, the second biobased monomer being in particular ethylene glycol.

In a particular embodiment of the present invention, the biobased polymer comprises a polyester based on a furan-2,5-dicarboxylic acid or one of its ester derivatives of formula V

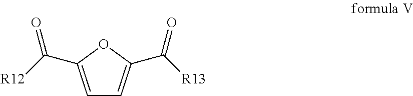

where R12 and R13 each independently contain an —OR14, where R14 is in each case independently a hydrogen or a linear, branched and/or cyclic substituted or unsubstituted hydrocarbyl group having 1 to 20 carbon atoms, which optionally contains O, N or S atoms, and on an ethylene glycol or polyethylene glycol of formula VI

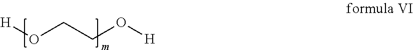

where m is not less than 1, preferably m is not less than 1 to 20, more preferably m is not less than 1 to 10. In particular cases, m is not less than 1 to 6.

The polymer is preferably a polyethylene furanoate (PEF) of formula IV,

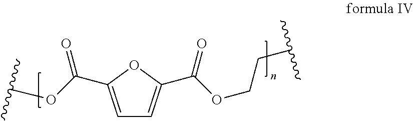

where n is above 2. Embodiments in each of which n is not less than 10 to 500, 100 to 1000, 500 to 5000, preferably 5000 to 10 000 are in particular.

The present invention provides a biobased polymer that is a polyethylene furanoate of formula IV. The advantage of polyethylene furanoate is that not only is it less costly to produce from PET, by virtue of utilizing the globally available biomass, but also has inter alia better barrier and thermal properties than PET. A further advantage of the present invention is the biodegradability of the biobased polymers preferably of the polyesters.

Especially through a respectively aerobic and/or anaerobic degradation through microorganisms, isolated enzymes, enzyme mixture or environmentally mediated degradation. Preference is given to a polyester that is 60%, 80%, more preferably 100% biodegradable. Preference is given to a degradation that meets the biodegradability requirements of the European standard EN 13432/EN 14995.

The present invention further provides a biobased polymer useful in the manufacture of biobased sheetlike elements and/or fibrous structures. Preference is given to a biobased polymer comprising flexible and/or elastic or inflexible and/or inelastic sheetlike elements and/or fibrous structures. Flexibility and elasticity is preferably understood as meaning low stiffness. The sheetlike elements are selected from

(i) sheetlike elements comprising spun, woven and/or molten sheetlike elements such as nonwovens, foils, wovens, scrims, especially flyscreens, nets, textiles and textile tapes, and/or
(ii) fibrous structures comprising spun, woven and/or molten fibers such as yarns, loop-drawn knits, braids, loop-formed knits, filaments, which are each independently particularly suitable for production of flyscreens, ropes, lines and cordage. Particular preference is given to those biobased sheetlike elements and/or fibrous structures comprising a polyester of formula IV, more preferably those comprising polyethylene furanoate. In a particular implementation, every one of the aforementioned sheetlike elements and fibrous structures is biodegradable within the meaning of the European standard EN 13432/EN 14995.

The invention similarly provides a process for preparing a biobased polyester and also the polyester obtainable thereby, comprising the steps of

1. converting a biobased monomer of formula I

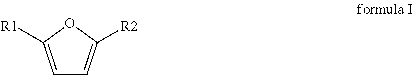

where
R1 is a carboxyl group and by way of substituent contains a linear, branched and/or cyclic substituted or unsubstituted hydrocarbyl group having 1 to 20 carbon atoms which optionally contains O, N or S atoms, or is a carboxylic acid group, an anhydride or a carboxylate group with a water-soluble counterion, in particular a process for preparing a water-soluble biobased monomer of formula I. Preferably the counterion is selected from the alkali or alkaline earth metals or zinc salt is the counterion of the carboxylic group, preferably the hydrocarbyl group may comprise a carbohydrate, and independently
R2 is a carboxyl group and by way of substituent comprises a linear, branched and/or cyclic substituted or unsubstituted hydrocarbyl group having 1 to 20 carbon atoms, or is a carboxylic acid group, an anhydride or a carboxylate group with a water-soluble counterion, more particularly the counterion is as defined above, R2 may preferably comprise a carbohydrate group.
   2. Performing a polycondensation between the biobased monomer of formula I and the second biobased monomer, the hydroxyl-functional compound, wherein the second biobased monomer is a polyol. Optionally the polycondensation is carried out in the presence of a condensation catalyst, and a biobased polymer is obtained.

Preferred catalysts comprise alkali metals and also Ca, Mg, Na, K, Zr, Zn, Pb, in particular Pb(II), Ti and Sn based catalysts. Preference for use as tin(IV) based catalysts in particular is given to organotin(IV) based catalysts, more preferably alkyltin(IV) salts comprising monoalkyltin(IV) salts, dialkyl- and trialkyltin(IV) salts, tin(II) octoate, and also mixtures thereof, titanium(IV) alkoxides or titanium(IV) chelates, zirconium(IV) chelates or zirconium(IV) salts (alkoxides for example), hafnium(IV) chelates or hafnium(IV) salts (alkoxides for example). Particularly preferred tin(IV) based catalysts are butyltin(IV) trisoctoate, dibutyltin(IV) dioctoate, dibutyltin(IV) diacetate, dibutyltin(IV) laureate, bis(dibutylchlorotin(IV)) oxide, dibutyltin dichloride, tributyltin(IV) benzoate and dibutyltin oxide.

It is particularly preferable for the polycondensation to be an esterification or transesterification of furandicarboxylic acid with a volatile alcohol such as ethanol, methanol and to be carried out with ethylene glycol or a diol or triol. The polycondensation is preferably carried out as an emulsion polymerization process.

Phase transfer catalysts are preferably used as condensation catalysts in any emulsion polymerization. Alternatively, it is also possible to use catalysts that can be distilled off together with any released alcohol and therefore are soluble in alcohols. Preference is given to using metal-free catalysts in order to avoid the formation of colored by-products.

In a further preferred version of the process, the biobased monomer of formula I is a furan-2,5-dicarboxylic acid (FDCA) derived by dehydration of sugars comprising pentoses and hexoses such as fructose, and specifically subsequent oxidation via the formation of prepolymers of formula III such as hydroxyfurfural, or is a derivative thereof.

The invention further provides a process in which the hydroxyl-functional compound is a biobased ethylene glycol derived in particular by

1. dehydrating bioethanol obtained from the fermentation of carbohydrates such as starch and/or sugar to ethene,
2. oxidizing to ethylene oxide, and
3. ring opening in the presence of water and ethanol to obtain ethylene glycol, wherein the ethanol is biobased.

The invention alternatively provides a process for preparing a biobased polyester and also the polyester obtainable thereby, in which
the step of deriving the premonomers of formula III from biomass comprising carbohydrates comprises dehydrating the biomass, while in formula III

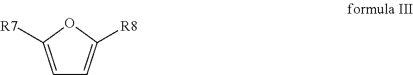

R7 is independently selected from the group comprising a linear, branched and/or cyclic substituted or unsubstituted hydrocarbyl group having 1 to 20 carbon atoms, which optionally contains O, N or S atoms, —CO—R9, —(CH₂)ₓ—O—R9, —O—R9 and hydrogen, and R8 is independently selected from the group comprising a linear, branched and/or cyclic substituted or unsubstituted hydrocarbyl group having 1 to 20 carbon atoms, which optionally contains O, N or S atoms, and —CO—R9, —(CH₂)ₓ—O—R9, —O—R9 and hydrogen, where R9 in each case is independently selected from the group comprising a linear, branched and/or cyclic substituted or unsubstituted hydrocarbyl group having 1 to 20 carbon atoms, which optionally contains O, N or S atoms, and hydrogen and x is in each case independently an integer between 1 and 10, preferably not less than 1 to 8, more preferably not less than 1 to 6.
The previously derived premonomers of formula III or mixtures comprising two or more premonomers of formula III are contacted with an oxidizing agent, in particular molecular oxygen or at least one peroxide, under acidic conditions, in particular a solution or dispersion, preferably comprising organic acids, more preferably acids having a pKa of not more than 4 comprising acetylic acid, formic acid and/or alkylcarboxylic acid and also derivatives thereof, optionally in the presence of a catalyst or of a mixture of catalysts, in particular of a metal catalyst or of a metal catalyst mixture comprising alkali metals, salts of Ca, Mg, Na, K, Zr, Zn, Pb, Ti and Sn, in particular Pb(II), Sn(IV), Sn(II), Co, Ni, Mn, Br, Zr and/or Ce and also Ziegler-Natta catalysts comprising transition metals, all as defined above.
This is followed by the reaction of the contacted compounds to form at least one biobased monomer of formula I and water.
Then, the water previously formed is removed, in particular by distillation, steam distillation, vaporization, in vacuo and/or extraction or using a dehydrating agent comprising compounds having water-scissioning properties such as concentrated sulfuric acid, phosphoric acid and anhydrous zinc chloride, to obtain biobased monomers of formula I,

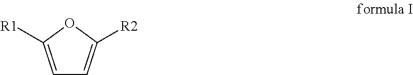

wherein R1 independently is a hydrogen or an organofunctional group of 1 to 20 carbon atoms, said organofunctional group optionally containing O, N or S atoms, and R2 independently is an organofunctional group of 1 to 20 carbon atoms, which optionally contains O, N or S atoms. More particularly, the hydrocarbyl group may be an alkyl, alkylaryl, alkylene or aryl group or derivatives thereof or a polyhydroxyhydrocarbon such as sugar, in which case the hydrocarbyl group optionally contains O, N or S atoms.
In a subsequent step, the monomers previously obtained are contacted with a hydroxyl-functional compound, in particular a monool and/or polyol, more preferably at least one diol and polyol, optionally in the presence of a catalyst, preferably in a solution or dispersion with a catalyst or with a catalyst mixture, followed by
a reaction of the contacted monomers and of the hydroxyl-functional compounds to form a polymer, in particular by emulsion polymerization, esterification, melt state polycondensation, solid state polycondensation and/or condensation. The biobased polymer obtained is preferably a polyester. The reaction to obtain the biobased polymer is preferably a polycondensation in the form of an esterification or interesterification.

The premonomers are more particularly derivable through aerobic and/or anaerobic microbial and/or enzymatic degradation of biomass, in particular through isolated enzymes or enzyme mixture. Preference is given to using a biomass that has a high energy potential, selected from vegetable origin such as wood, natural fibers especially cellulose and its derivatives, plant oils and also sugar and starch, in particular biogenic waste products such as agricultural wastes and food wastes comprising carbohydrates. Examples of agricultural waste are bagasse (comprising oat bran, corn cob residues), wood wastes and straw comprising cellulose, xylan and lignin.

Preference is given to a process where step 1 comprises deriving the premonomers of formula III from biomass comprising carbohydrates, wherein the premonomer is a furan derivative selected from an alkoxymethylfuran and/or dialkoxymethylfuran, preferably a 2,5-bis(alkoxymethyl)furan, a furfural (furanaldehyde, R—(C═O)H) selected from the group comprising alkoxymethylfurfural, 5-hydroxymethylfurfural (HMF), 2-ethoxymethylfurfural (EMF) and 5-ethoxymethylfurfural (EMF) or mixtures comprising two or more premonomers of formula III, preferably comprising two or more thereof and steps 3 and 4 comprise forming the biobased monomers of formula I,

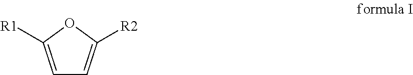

where in each case R1 is a carboxyl group and by way of substituent contains a linear, branched and/or cyclic substituted or unsubstituted hydrocarbyl group having 1 to 20 carbon atoms. In particular, the hydrocarbyl group may be an alkyl, alkylaryl, alkylene or aryl group or derivatives thereof or a polyhydroxyhydrocarbon such as sugar, in which case the hydrocarbyl group optionally contains O, N or S atoms, or R1 is a hydrogen and R2 is a carboxyl group and by way of substituent comprises a linear, branched and/or cyclic substituted or unsubstituted hydrocarbyl group having 1 to 20 carbon atoms.

The biobased monomers formed are preferably of formula II,

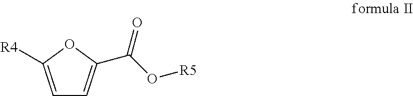

where R4 is selected from the group comprising hydrogen, an organofunctional group of 1 to 20 carbon atoms, particularly a carboxyl group, and by way of substituent a linear, branched and/or cyclic substituted or unsubstituted hydrocarbyl group having 1 to 20 carbon atoms. The hydrocarbyl group may more particularly be an alkyl, alkylaryl, alkylene or aryl group or derivative thereof or a polyhydroxyhydrocarbon such as sugar, in which case the hydrocarbyl group optionally contains O, N or S atoms. R4 is preferably a carboxyester where the ester is derived from dihydroxy compounds, and R5 is selected from the group comprising hydrogen, a linear, branched and/or cyclic substituted or unsubstituted hydrocarbyl group having 1 to 20 carbon atoms. More particularly, the hydrocarbyl group may be an alkyl, alkylaryl, alkylene or aryl group or derivative thereof or a polyhydroxyhydrocarbon such as sugar, in which case the hydrocarbyl group may optionally contain O, N or S atoms.

The process described is preferably used to derive biobased polymers, in particular polyesters, comprising a reaction of biobased furan-2,5-dicarboxylic acid or its ester derivatives and a biobased diol comprising glycol. It is preferably a polymer of formula IV, more preferably the polyethylene furanoate derived from a reaction of furan-2,5-dicarboxylic acid or of one of its ester derivatives and an ethylene glycol.

Further alternative furan derivatives useful as starting materials are described in EP 0 230 250 B1, EP 0 561 928 B1 and US 2012/283452 A.

Further processes and worked examples of the process that are useful for producing the biobased polymer of the present invention, in particular the biobased polyester, in particular carrier materials therefrom are described in US 2011/092720 A, US 2009/306415 A and also US 2012/271060.

The present invention further provides an article of manufacture comprising the biobased polymer described above, in particular the polyester of the present invention, preferably a polyester of formula IV, more preferably polyethylene furanoate (PEF), in the form of sheetlike elements and/or fibrous structures selected from

(i) sheetlike elements comprising spun, woven and/or molten sheetlike elements such as nonwovens, foils, wovens, scrims, especially flyscreens, nets, textiles and textile tapes,
(ii) fibrous structures comprising spun, woven and/or molten fibers such as yarns, loop-drawn knits, braids, loop-formed knits, filaments and also articles of manufacture comprising combinations of the particular structures.

The invention similarly provides articles of manufacture comprising adhesive tapes, in particular a carrier material for one- and two-sided adhesive tapes, preferably a carrier material for adhesive tapes to envelop elongate gear comprising electrical lines, in particular cables, cable harnesses and wires, preferably cables and cable harnesses in automotive interior applications. Further articles of manufacture comprise facing materials, transfer materials, transfer foils, release liners or carrier material for cable wrapping tapes.

The present invention further provides the method of using the biobased polymer described above, in particular the polyester, preferably PEF in the manufacture of specifically flexible and/or elastic and/or inflexible and/or inelastic biobased sheetlike elements and/or biobased fibrous structures selected from

(i) sheetlike elements comprising spun, woven or molten sheetlike elements such as nonwovens, foils, release liners, wovens, scrims, especially flyscreens, nets, textiles and textile tapes and
(ii) fibrous structures comprising spun, woven or molten fibers such as yarns, loop-drawn knits, braids, loop-formed knits and filaments and also combinations thereof.

Particularly preferred biobased sheetlike elements and/or fibrous structures are carrier materials or articles of manufacture that are useful in the manufacture of adhesive tapes, cable wrapping tapes, die cuts, foils, release liners, OLEDs, facing material and transfer material. In one particular implementation, the carrier material in polyethylene furanoate is useful as carrier material for adhesive tapes, cable wrapping tapes, foils, OLEDs, facing material and transfer material.

The present invention further provides the method of using the biobased sheetlike elements and/or fibrous structures of the present invention and also an article of manufacture for the purposes of the invention in the manufacture of foils and/or carrier materials, in particular of foils and/or carrier materials for production of adhesive tapes, in particular for production of carrier materials for adhesive tapes as per LV-312 to protect from abrasion, to noise-dampen, insulate, sheath, bundle, position and fix elongate gear, in particular electrical lines comprising cables and wires as per LV-312.

The present invention provides in particular a biobased carrier material comprising a biobased polymer, in particular the biobased polyester, preferably the PEF in the form of

(i) sheetlike elements comprising spun, woven and/or molten sheetlike elements such as nonwovens, foils, wovens, scrims, nets, textiles and textile tapes, and/or
(ii) fibrous structures comprising spun, woven and/or molten fibers such as yarns, loop-drawn knits, braids, loop-formed knits, filaments, which are each independently or in combination particularly suitable for production of ropes, lines and cordage and also combinations thereof, in particular for use in adhesive tapes or in the manufacture of an adhesive tape.

Carrier materials for the purposes of the invention are materials suitable for coating with an adhesive composition. As such they comprise sheetlike carriers as described hereinbelow.

To form a carrier material for an adhesive tape in particular, the biobased polymers of the present invention, in particular the biobased polyesters, preferably the PEF may be provided in the form of any known textile carriers such as drawn-loop knits, NCFs, tapes, braids, needle pile textiles, felts, wovens (comprising plain, twill and satin weaves), formed-loop knits (comprising warp-knitted fabric and knitwear fabric) or nonwovens, where “nonwoven” is to be understood as meaning at least textile sheetlike structures as defined in EN 29092 (1988) plus stitch-bonded fiberwebs and similar systems.

The biobased polymer of the present invention, in particular the biobased polyester, preferably PEF may likewise be used as a laminated spacer fabric formed by weaving or formed-loop knitting. Woven spacer fabrics of this type are disclosed in EP 0 071 212 B1. Woven spacer fabrics are mat-shaped layered product having a top layer comprising a fibrous or filamentous web, a bottom layer and therebetween individual or bushels of holding fibers needled through the particle layer in a distributed form across the area of the layered product to join the top and bottom layers together. EP 0 071 212 B1 provides by way of an additional but inessential feature that particles of inert rock such as, for example, sand, gravel or the like be present in the holding fibers. The holdings fibers needled through the particle layer hold the bottom and top layers spaced apart and connect to the top layer and the bottom layer.

The biobased polymer of the present invention, in particular the biobased polyester, preferably the PEF are processable in the form of nonwoven fabrics, particularly as consolidated staple fiber webs, but also filamentous, melt-blown and also spunbonded webs, which usually need additional consolidation. Possible methods of consolidation are derivable from the prior art.

The biobased polymers of the present invention, in particular the polyester, preferably the PEF, have proved to be particularly advantageous as nonwovens consolidated specifically by overstitching with separate threads or by interloping. Consolidated nonwovens of this type are obtainable, for example, on stitch-bonding machines of the “Malimo” type from Karl Mayer. A Malifleece nonwoven is characterized in that a cross-laid web is consolidated by the formation of loops from fibers of the fiberweb. The carrier used as comprising a biobased polymer, specifically polyester, preferably PEF, of the present invention may further be a Kunit or Multiknit nonwoven. A Kunit nonwoven is characterized in that it originates from the processing of a longitudinally oriented fiberweb into a sheetlike structure which has the loops on one side, and, on the other, loop feet or pile fiber folds, but possesses neither threads nor prefabricated sheetlike structures. A further characterizing feature of this nonwoven is that, as a longitudinal fiberweb, it is able to absorb high tensile forces in the longitudinal direction. A Multiknit nonwoven is characterized in relation to the Kunit nonwoven in that the nonwoven is consolidated on both the top and bottom sides by the double-sided needlepunching.

Finally, the polymer of the present invention, in particular the polyester, preferably PEF is useful in the manufacture of stitched nonwovens as a precursor to the formation of an adhesive tape according to the present invention. A stitched nonwoven is formed from a web material having a large number of mutually parallel seams. These seams are formed by stitching or knitting in continuous textile threads, preferably textile threads comprising the polymer of the present invention, in particular the polyester, preferably PEF.

Also of particular suitability are needlefelts comprising the polymer of the present invention, in particular of the polyester, preferably PEF. In a needlefelt, a fiberweb is converted into a sheetlike structure by means of barbed needles. The needles are alternatingly punched into and pulled out of the material to consolidate the material on a needlebeam, since the individual fibers become entangled to form a firm sheet. The number and configuration of needling points (needle shape, depth of penetration, both-sided needling) are decisive in determining the thickness and firmness of the fibrous structures, which are invariably lightweight, air pervious and elastic.

The polymer of the present invention, in particular the polyester, preferably PEF, is further very useful in the manufacture of staple fiber web which, in the first step, is preconsolidated by mechanical processing or which is a wet-laid web laid hydrodynamically, while between 2 wt % and 50 wt % of the fibers of the web are fusible fibers, especially between 5 wt % and 40 wt % of the fibers of the web. A web of this type is characterized in that the fibers are wet laid or, for example, a staple fiber web is preconsolidated by the formation of loops from fibers of the web, by needling, stitching, air and/or water jet processing.

A second step comprises heat setting whereby the strength of the web is further enhanced by the complete or incipient melting of the fusible fibers.

Particularly the adhesive consolidation of mechanically preconsolidated or wet-laid nonwovens is of interest for utilizing nonwovens in the manner of the present invention, it may be effected via admixture as per the prior art of binder in solid, liquid, foamed or pasty form.

The carrier comprising the biobased polymer of the present invention, in particular the polyester, preferably PEF, may advantageously and at least regionally have a one- or both-sidedly polished surface, preferably a fully polished surface on both sides. The polished surface may be chintzed as detailed in EP 1 448 744 A1 for example.

The polymeric carrier of the present invention may further be calendered for densification in a rollstand as described in the prior art. The biobased polymer of the present invention, in particular the polyester, preferably PEF is further likewise useful in the manufacture of yarns.

Wovens or NCFs comprising the biobased polymer, in particular the polyester, preferably PEF, may additionally have individual threads made of a hybrid yarn, i.e., comprising synthetic and natural constituents. Preferably, however, warp and weft threads are each in the present invention formed from the biobased polymer, in particular polyester, preferably PEF, in a varietally pure manner.

Finally, the biobased polymer of the present invention, in particular the polyester, preferably PEF is useful in the manufacture of a covering material for adhesive tapes whereby the one or two adhesive layers are covered up until needed for use. Useful covering materials also include any of the materials referred to in detail above. Preference is given to employing a non-linting material such as a plastics foil made of the biobased polymer of the present invention, in particular the polyester, preferably PEF, or an efficiently sized long-fiber paper coated with the biobased polymer of the present invention, in particular with the polyester, preferably PEF.

Low flammability desired for the adhesive tape described is obtainable by adding flame retardants to the carrier of the present invention and/or the adhesive material. These flame retardants may be organobromine compounds, combined if necessary with synergists such as antimony trioxide, although red phosphorus, organophosphorus, mineral or intumescent compounds such as ammonium polyphosphate alone or combined with synergists are used with preference with a view to freedom from halogen for the adhesive tape.

The biobased polymer of the present invention, in particular the polyester, preferably PEF is likewise useful in the manufacture of foils. Foils are for example usually thinner than textiles, offer by virtue of their uninterrupted layer additional protection from the ingress of chemicals and consumables such as oil, gasoline, antifreeze and the like into the actual cabled region and are substantially conformable to requirements by suitably selecting their material of construction. Hitherto, conformation was achieved through polyurethanes, copolymers of polyolefins for example for a flexible and elastic sheathing, while good abrasion and high temperature resistances were attained through polyesters and polyamides. These requirements are now achieved through the biobased polymer of the present invention, in particular the polyester, preferably PEF.

The biobased polymer of the present invention, in particular the polyester, preferably PEF is likewise useful in the manufacture of foamed foils which inherently have the property of greater bulk and also good noise suppression—where a cable strand is installed for example in a channel or tunnel type region in the vehicle, a sheathing tape of appropriate thickness and damping can be used to prevent any troublesome flapping and vibration from occurring in the first place.

In a further advantageous embodiment, the carrier material made of the biobased polymer according to the present invention, in particular the polyester, preferably PEF, a sheeting-shaped carrier, in particular a foil, woven or nonwoven carrier or paper carrier or a composite carrier coated with/comprising the biobased polymer of the present invention, in particular the polyester, preferably PEF.

The separately described forms of the biobased sheetlike elements and fibrous structures are combinable if desired. As an example—without any limitation being implied—a sheetlike element, in particular a woven fabric, may have to be reinforced with a fibrous structure, in particular yarns or filaments.

The present invention further provides an adhesive tape, in particular to protect substrates from abrasion, dirt, moisture and/or the action of heat, to noise-dampen, insulate, sheath, bundle, sheath cables, bundle cables, position and fix elongate gear, in particular as per the requirements of classes A, B, C, D and/or E, comprising a) a biobased carrier material within the meaning of the present invention, b) either or both of the surfaces of the biobased carrier material being provided at least one adhesive material, in particular pressure-sensitive adhesive and hot-melt adhesive, material, and optionally c) at least one facing material, in particular to cover the one- and/or both-sidedly applied adhesive material until the planned use and/or transfer material, in particular for easier handling of the adhesive tape inter alia for easier rolling up and unrolling of the adhesive tape.

Preference is given to a facing and/or transfer material comprising the biobased polymer of the present invention, in particular the polyester, preferably PEF.

The adhesive tape of the present invention may comprise one or more layers of foils or foam carriers. The adhesive tape may further comprise one or more functional layers such as facing materials and transfer layers comprising hotmelt-capable material or other functional layers.

In a preferred embodiment, the transfer material is the reverse side of the facing material, characterized in that in the rolled-up state of the adhesive tape (roll) the facing material and the transfer material are arranged one above the other and adhere to each other while at the same time, when the adhesive tape is unrolled, detachment of the facing material and of the transfer material from each other is enabled without baring the adhesive present therebetween especially in the case of a both-sidedly tacky adhesive tape. In one advantageous embodiment, the facing material or transfer material is the reverse side of the carrier according to the present invention whereto the adhesive is applied.

Pressure-sensitive adhesives advantageous for the purposes of this invention include for example without limitation the following: acrylate, silicone, natural rubber, synthetic rubber, and styrene block copolymer compositions, with an elastomer block composed of hydrogenated or unsaturated polydiene blocks (polybutadiene, polyisoprene, copolymers of the two and also further elastomer blocks familiar to a person skilled in the art) and also further pressure-sensitive adhesives familiar to a person skilled in the art, for which specifically silicone-containing release coatings are usable. Any reference herein to acrylate-based pressure-sensitive adhesives shall be taken to comprehend even absent any explicit mention pressure-sensitive adhesives based on methacrylates and on acrylates and methacrylates unless expressly stated otherwise. Also usable for the purposes of the invention are combinations and blends of two or more base polymers and also adhesives additized with tackifier resins, fillers, aging control agents and crosslinkers. Preference is given to using adhesives based on biobased resins in order to obtain a fully biobased adhesive tape of unchanged adhesive power. Preference is given to using a biobased adhesive that is biodegradable. The adhesive is preferably not less than 30 wt % biodegradable, more preferably not less than 40 wt % biodegradable.

Recourse may be had to any known adhesive systems. In addition to adhesives based on natural or synthetic rubber, it is specifically silicone adhesives and also polyacrylate adhesives, preferably an acrylate hotmelt pressure-sensitive adhesive, that are usable. Owing to their particular usefulness as adhesive material for wrapping tapes for automotive wire harnesses with regard to fogging resistance and also their excellent compatibility with PVC and also PVC-free core insulations, solvent-free acrylate hotmelt compositions as more particularly described in DE 198 07 752 A1 and DE 100 11 788 A1 are preferable.

Add-on weight is preferably in the range between 15 to 200 g/m², more preferably 30 to 120 g/m² (roughly corresponding to a thickness of 15 to 200 μm, more preferably 30 to 120 μm).

The adhesive is preferably a pressure-sensitive adhesive, i.e., an adhesive which provides a durable bond to almost any substrate under relatively light pressure and is redetachable from the substrate after use essentially without leaving a residue. A pressure-sensitive adhesive is permanently tacky at room temperature, i.e., has a sufficiently low viscosity and a high initial tack, so it will wet the surface of the particular substrate under minimal pressure. The adherability of the adhesive material rests on its adhesive properties and the redetachability on its cohesive properties.

One suitable adhesive is based on an acrylate hotmelt with a K value of at least 20 and more particularly above 30 (measured in each case in 1 wt % solution in toluene, 25° C.), obtainable by concentrating a solution of such a composition to give a system which can be processed as a hotmelt.

K value (after FIKENTSCHER) is a measure of the average molecular size of high polymers. The viscosity of polymers is determined using a capillary viscometer in accordance with DIN EN ISO 1628-1:2009.

The measurement is carried out by preparing one-percent (1 g/100 ml) polymer solutions in toluene at 25° C. and measuring these using the corresponding DIN Ubbelohde viscometer according to ISO 3105:1994 Table B.9.

Concentrating can take place in appropriately equipped tanks or extruders, particularly in the case of the attendant devolatilization the preference is for a devolatilizing extruder. An adhesive of this type is set forth in DE 43 13 008 C2. In an intermediate step, the solvent is completely removed from the acrylate compositions thus obtained.

In addition, further volatile constituents are removed in the process. After coating from the melt, these compositions have only small residual fragments of volatile constituents. Accordingly it is possible to adopt all the monomers/recipes that are claimed in the patent cited above.

The solution of the composition may contain 5 to 80 wt %, especially 30 to 70 wt % of solvent.

Commercially available solvents are employed with preference, in particular low-boiling hydrocarbons, ketones, alcohols and/or esters.

Preference is further given to single-screw, twin-screw or multi-screw extruders having one or, in particular, two or more devolatilizing units.

The acrylate hotmelt-based adhesive may comprise copolymerized units of benzoin derivatives, for example benzoin acrylate or benzoin methacrylate, acrylic or methacrylic esters. Benzoin derivatives of this type are described in EP 0 578 151 A.

The acrylate hotmelt-based adhesive may be UV crosslinkable. However, other types of crosslinking are also possible, for example electron beam crosslinking.

A further preferred embodiment utilizes self-adhesive compositions comprising copolymers of (meth)acrylic acid and esters of 1 to 25 carbon atoms, maleic, fumaric and/or itaconic acids and/or esters thereof, substituted (meth)acrylamides, maleic anhydride and other vinyl compounds, such as vinyl esters, in particular vinyl acetate, vinyl alcohols and/or vinyl ethers.

Residual solvent content shall be below 1 wt %.

One adhesive which will be found to be particularly suitable is an acrylate pressure-sensitive hotmelt adhesive of the kind marketed by BASF under the name acResin, in particular acResin A 260 UV. This adhesive, which has a low K value, acquires its use-appropriate properties via a final radiation-induced crosslinking operation.

Further outstandingly suitable adhesive compositions are described in the documents DE 10 2011 075 152 A1, DE 10 2011 075 156 A1, DE 10 2011 075 159 A1 and DE 10 2011 075 160 A1.

The carrier face is preferably wholly coated with the adhesive.

The adhesive may be applied in the longitudinal direction of the adhesive tape, in the form of a stripe having a width less than that of the adhesive tape carrier material. In one advantageous embodiment, the coated stripe has a width amounting to 10 to 80% of the width of the carrier material. The use of stripes having a coating of 20 to 50% of the width of the carrier material is particularly preferable.

Depending on the use scenario it is also possible for two or more parallel stripes of adhesive to be coated on the carrier material.

The position of the stripe on the carrier is freely choosable, although a disposition directly at one of the edges of the carrier is preferred.

It is further possible to provide two stripes of adhesive—one stripe of adhesive on the topside of the carrier material and one stripe of adhesive on the underside of the carrier material, in which case the two stripes of adhesive are preferably disposed at opposite longitudinal edges. In one version, the two stripes of adhesive are disposed at one and the same longitudinal edge.

The stripe or stripes of adhesive preferably each terminate flush with the longitudinal edge or edges of the carrier material.

The adhesive coating of the carrier may be provided atop one or more stripes of a covering which extend in the longitudinal direction of the adhesive tape and cover between 20% and 90% of the adhesive coating.

The stripe preferably covers altogether between 50% and 80% of the adhesive coating. The degree of coverage is chosen according to the use and the diameter of the cable harness.

The recited percentages are based on the width of the stripes of covering in relation to the width of the carrier.

In one preferred embodiment of the invention, one stripe of covering is present on the adhesive coating.

The position of the stripe on the adhesive coating is freely choosable, a disposition directly at one of the longitudinal edges of the carrier being preferred. This results in an adhesive strip which extends in the longitudinal direction of the adhesive tape and terminates at the other longitudinal edge of the carrier.

When the adhesive tape is employed for sheathing a cable harness by guiding the adhesive tape helically around the cable harness, the enveloping of the cable harness may be effected such that the adhesive on the adhesive tape only adheres to the adhesive tape itself, while the gear does not come into contact with any adhesive. The cable harness thus sheathed has a very high level of flexibility by virtue of the cables not being fixed by any adhesive. This distinctly enhances the bendability of the cable harness at installation, specifically also in narrow passages or sharp bends.

When a certain degree of fixing of the adhesive tape to the gear is desired, the sheathing may be accomplished by bonding the adhesive stripe partly to the adhesive tape itself and partly to the gear.

In another advantageous embodiment, the stripe is applied centrally to the adhesive coating, resulting in two adhesive stripes extending along the longitudinal edges of the carrier in the longitudinal direction of the adhesive tape.

The adhesive stripes each positioned along the longitudinal edges of the adhesive tape are advantageous to securely and economically apply the adhesive tape in said helical movement around the cable harness and to prevent slippage of the resultant protective sheathing, particularly when one of the adhesive stripes, which is usually narrower than the second stripe, serves as fixing aid and the second, broader stripe serves as a fastener. In this way, the adhesive tape adheres to the cable such that the cable harness is secured against slippage but is nonetheless flexible.

There are further also embodiments wherein two or more stripes of covering are applied atop the adhesive coating. Any reference to merely one stripe is automatically inferred by the skilled reader as meaning that it is entirely also possible for two or more stripes to cover the adhesive coating at one and the same time.

The adhesives may be prepared and processed from solution, from dispersion and also from the melt. Preferred production and processing operations take place from solution and also from the melt. Particular preference is given to fabricating the adhesive from the melt, in which case it is more particularly possible to use batch processes or continuous processes. The continuous fabrication of pressure-sensitive adhesives using an extruder is particularly advantageous.

The adhesives thus obtained can then be applied to the carrier using the generally/commonly known processes. In the case of processing from the melt, these can be application processes via a nozzle or a calender.

In the case of processes from solution, coatings with rods, blades or nozzles are known, to name but a few.

It is also possible to transfer the adhesive from a non-stick carrier cloth or release liner onto the carrier assembly.

Finally, the adhesive tape may include a covering material to cover the one or two adhesive layers until use. Useful covering materials also include any of the materials recited at length above.

Preference, however, is given to a non-linting material such as a polymeric foil or a highly sized long-fibered paper.

The reverse side of the adhesive tape may be coated with a reverse-side lacquer in order that a favorable influence may be exerted on the unwind properties of the adhesive tape wound to an Archimedean spiral. For this purpose, the reverse-side lacquer may be coated with silicone or fluorosilicone compounds and also with polyvinylstearylcarbamate, polyethyleneiminestearylcarbamide or organofluorine compounds as abhesive/dehesive chemistries. Optionally, a foam coating is present on the reverse side of the adhesive tape under the reverse-side lacquer or alternatively thereto.

The adhesive tape of the present invention may be provided in fixed lengths, as for example in the form of piece goods, or else as a continuous product on rolls (Archimedian spiral). In the latter case, for use, it is possible to separate off lengths as desired by using blades, scissors or dispensers and the like, or manually without ancillaries.

The adhesive tape may further have one or more weakening lines at right angles to its linear direction, making the adhesive tape easier to tear by hand.

In order to allow particular user convenience, the weakening lines are aligned at right angles to the linear direction of the adhesive tape and/or are disposed at regular intervals.

The adhesive tape is particularly simple to sever when the weakening lines are configured in the form of perforations.

This makes it possible to obtain edges between the individual portions that are highly nonlinting, thereby preventing undesirable fraying.

The weakening lines are particularly advantageous to produce discontinuously using flat dies or transversely operating perforating wheels, or continuously using rotary systems such as spiked rollers or punch rollers, optionally with the use of a counter-roller (Vulkollan roller) forming the counter-wheel during cutting.

Further possibilities include cutting technologies controlled to operate intermittently, such as the use of lasers, ultrasound, high pressure water jets, etc., for example. Where, as in the case of laser or ultrasound cutting, some of the energy is introduced into the carrier material in the form of heat, fibers can be fused in the cut region to thereby very largely prevent any noticeable fraying and obtain cleanly cut edges. The latter methods are also suitable for obtaining specific cut edge geometries, for example cut edges with concave or convex shaping.

The height of the spikes or blades on the punch rollers preferably amounts to 150% of the thickness of the adhesive tape.

The hole/bridge ratio in the case of perforation—that is, the ratio of the number of millimeters holding the material together (“bridge”) to the number of millimeters where it is apertured—determines how easily specifically the fibers of the carrier material are to tear. This ratio further ultimately also influences the extent to which the torn edge is nonlinting.

Bridge width is preferably about 2 mm, while the cut width between bridges is about 10 mm, i.e., bridges 2 mm in width alternate with incisions 10 mm in length. The hole/bridge ratio is therefore preferably 2:10.

This weakening of the material provides a sufficiently low tearing force.

The present invention similarly provides a process for forming an adhesive tape that is in accordance with the present invention, comprising
(1) providing the carrier material, particularly in the form of a sheetlike element,
(2) applying the adhesive as a layer to at least one of the two surfaces of the carrier material, and
(3) optionally covering the adhesive with a facing material and/or transfer material.

Preference is given to a process which further comprises rolling up the resulting one- or two-sidedly tacky adhesive tape to form a roll or producing die cuts.

The process for forming an adhesive tape within the meaning of the invention comprises optionally a) applying the adhesive to the second surface of the carrier material, b) covering the adhesive with a facing material and/or a transfer material, and c) rolling up the resulting both-sidedly tacky adhesive tape to form a roll. The process preferably comprises rolling up the resulting two-sidedly tacky adhesive tape to form a roll or producing die cuts.

The general expression “adhesive tape” for the purposes of the invention comprehends any sheetlike structures such as two-dimensionally extended foils or foil portions, tapes of extended length and finite width, tape portions and the like, ultimately also die cuts or labels.

The adhesive tape is obtainable in the form of a roll, i.e., self-wound up in the form of an Archimedean spiral.

The adhesive coating of the carrier may be provided atop one or more stripes of a covering which extend in the longitudinal direction of the adhesive tape and cover between 20% and 90% of the adhesive coating. The stripe preferably covers altogether between 50% and 80% of the adhesive coating. The degree of coverage is chosen according to the use and the diameter of the cable harness. The recited percentages are based on the width of the stripes of covering in relation to the width of the carrier. In one preferred embodiment of the invention, one stripe of covering is present on the adhesive coating. There are further also embodiments wherein two or more stripes of covering are applied atop the adhesive coating.

The position of the stripe on the adhesive coating is freely choosable, a disposition directly at one of the longitudinal edges of the carrier being preferred. This results in an adhesive strip which extends in the longitudinal direction of the adhesive tape and terminates at the other longitudinal edge of the carrier.

When the adhesive tape is employed for sheathing a cable harness by guiding the adhesive tape helically around the cable harness, the enveloping of the cable harness may be effected such that the adhesive on the adhesive tape only adheres to the adhesive tape itself, while the gear does not come into contact with any adhesive. The cable harness thus sheathed has a very high level of flexibility by virtue of the cables not being fixed by any adhesive. This distinctly enhances the bendability of the cable harness at installation, specifically also in narrow passages or sharp bends. When a certain degree of fixing of the adhesive tape to the gear is desired, the sheathing may be accomplished by bonding the adhesive stripe partly to the adhesive tape itself and partly to the gear.

The manufacturing process for the adhesive tape of the present invention comprises coating the carrier with the adhesive in one or more successive operations. In the case of textile PEF carriers, the untreated textile is coatable directly or in a transfer process. Alternatively, the textile may be pretreated with a coating (with any film-forming chemistry from solution, dispersion, melt and/or radiatively curable) in order then, in a subsequent step, to be provided the pressure-sensitive adhesive directly or in a transfer process.

The invention also provides an elongate gear sheathed with an adhesive tape of the present invention. The elongate gear comprising electric lines preferably comprises a cable harness or wires.

Owing to the outstanding suitability of the adhesive tape comprising a carrier material preferably a woven or non-crimp fabric made of the biobased polymer according to the present invention, in particular the polyester, preferably PEF, it is usable in a sheath consisting of a covering wherein at least an edge region of the covering comprises the self-tacky adhesive tape, which bonds to the covering such that the adhesive tape extends along one of the longitudinal edges of the covering, and this preferably in an edge region that is narrow relative to the width of the covering.

The biobased polymer of the present invention, in particular the polyester, preferably PEF, is usable in embodiments of carriers and/or adhesive tapes as disclosed in EP 1 312 097 A1. EP 1 300 452 A2, DE 102 29 527 A1, WO 2006/108 871 A1 and also EP 2 520 629 A describe further embodiments and methods of sheathing wherefor the biobased polymer of the present invention, in particular a polyester, preferably PEF, is likewise very highly suitable.

Finally, EP 1 315 781 A1 and also DE 103 29 994 A1 describe embodiments of adhesive tapes that can likewise be made from the biobased polymer of the present invention, in particular a polyester, preferably PEF.

It is further preferable that the adhesive tape on bonding to cables with PVC sheathing and the cables with polyolefin sheathing does not destroy same when an assembly of cables and adhesive tape is stored in accordance with LV 312 at temperatures above 100° C. and up to 3000 h and the cables are subsequently bent round a mandrel.

The biobased polymer of the present invention, preferably PEF, is likewise suitable for production of release liners, covering materials and/or release material. Release liners are employed in the case of one- or both-sidedly adhesive-coated tapes in order to prevent that the pressure-sensitive adhesives come into contact with each other or become soiled before use or in order that an adhesive tape may be unrolled using a desired level of force (high or low). In the case of one-sidedly tacky adhesive tapes, a covering material and/or release material on the adhesive will ensure easier unrolling. Liners, in particular liners made of the biobased polymer of the present invention, in particular the polyester, preferably PEF, are also employed for covering labels. In the case of both-sidedly coated adhesive tapes, the release liners additionally ensure that the correct side of the adhesive is bared first during unrolling.

A liner or release liner (release paper, release foil) is not a constituent part of a label or adhesive tape, but merely an ancillary in the production, storage or further processing thereof by die cutting. Nor, in contradiction to an adhesive tape carrier, is a liner firmly joined to an adhesive layer.

Any preferred forms of implementing the invention that are applicable to the release liners above shall correspondingly be deemed as also preferable for the release liner above. It is particularly preferable for the material of the carrier foil to be made of the biobased polymer according to the present invention, in particular the polyester, preferably PEF.

### GENERAL EXEMPLARY EMBODIMENT

### Preparation of Premonomers

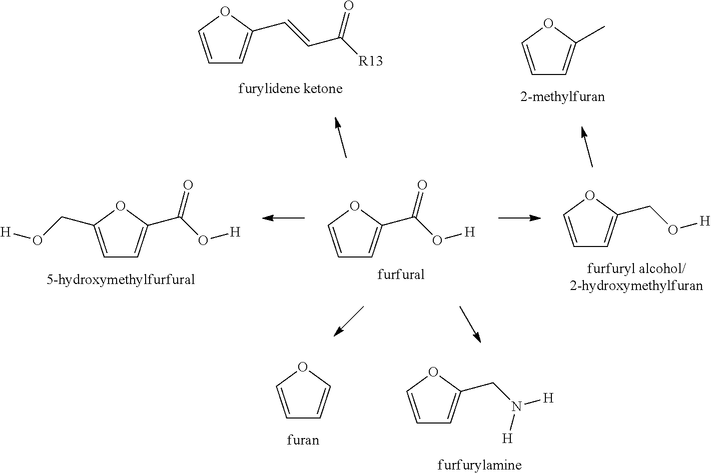

Examples regarding derivation of furfural
By distillation of bran with sulfuric acid after Döbereiner (1831).
Conversion of hemicellulose with dilute acid in steam into pentoses (monomeric building blocks of xylose), followed by dehydration to furfural.

### Preparation of PEF

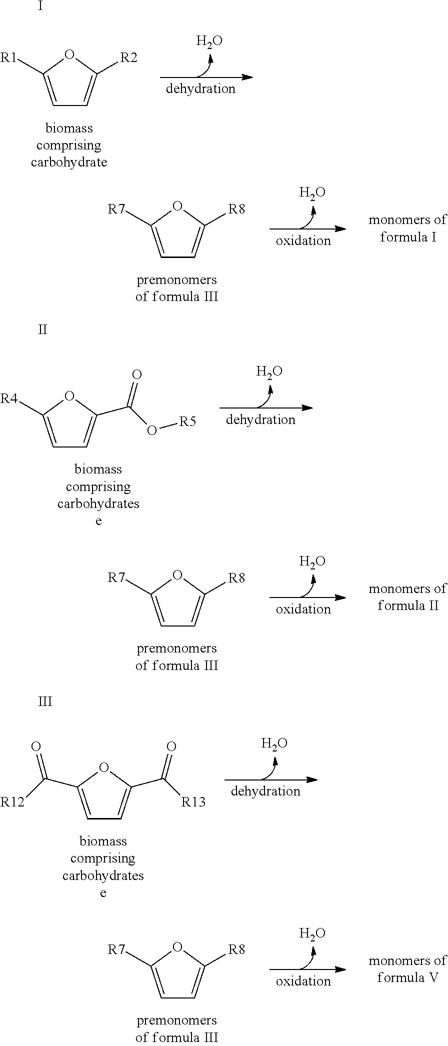

where R12 and R13 are each independently an —OH or an alkyl ether comprising a methyl, ethyl, propyl, butyl, pentyl and hexyl group, preferably a mono- or diethyl

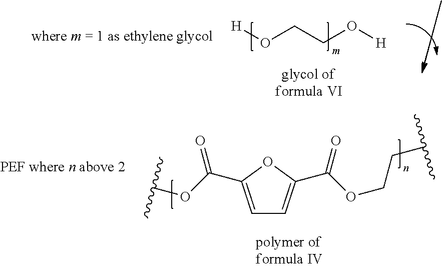

### Proportion of Regrowable Raw Materials in Thepolymers

The proportion of regrowable raw materials depends on the selection and amount of the feedstock materials used.

Even unknown samples are verifiable using the radiocarbon method of ASTM D6866-04. Said method involves measuring the ¹⁴C isotope which in nature (biomass) occurs in carbon at an abundance of 10⁻¹⁰%. Liquid scintillation spectrometry or mass spectroscopy is used to measure the ¹⁴C isotope. The basis for determining the proportion of regrowable raw materials is the fact that the ¹⁴C isotope has a comparatively short decay half-life of 5730 years. The ¹⁴C isotope is accordingly no longer detectable within the detection limit of the methods in carbon samples older than 60 000 years. The carbon in the petroleum-based raw materials of petrochemistry has an age of several million years and does not contain any detectable ¹⁴C.

PEF was prepared according to Example 6 of EP 2 370 496 A1 and processed into carriers. The carriers made thereof were further processed into adhesive tapes. The severe coloration of the polymer is disadvantageous for the tapes.

The invention will now be more particularly described by means of examples which shall not be construed as limiting the invention in any way.

Measurements were carried out in accordance with the following standards:
DIN EN ISO 2286-1 for basis weights of wovens and the adhesive coating
DIN 53830 Part 3 for yarn weight
DIN EN 1049 Part 2 for thread count
DIN EN 1939 for adherence
DIN EN 1942 for thickness of wovens and adhesive tapes

### Molecular Weight

The average specifically weight average molecular weight M_{w} and other average molecular weights are determined using gel permeation chromatography (GPC). The eluent used is THF containing 0.1% by volume of trifluoroacetic acid. The measurement is carried out at 25° C. The precolumn used is PSS-SDV, 5 μm, 10³ Å, ID 8.0 mm×50 mm. The separation columns used are PSS-SDV, 5 μm, 10³ Å, 10⁵ Å and 10⁶ Å each at ID 8.0 mm×300 mm. Sample concentration is 4 g/k, flow rate is 1.0 ml per minute. Measurement is done against PMMA standards. (μ=μm; 1 Λ=10⁻¹⁰ m).

### Woven Constructions

TABLE 1
Woven constructions of various PEF weave adhesive tapes

| | (I) | (II) | (III) | (IV) |
|---|---|---|---|---|
| carrier material | PEF weave | PEF weave | PEF weave | PEF weave |
| thread count | 48/cm | 32/cm | 40/cm | 50/cm |
| along (warp) | | | | |
| thread weight | 167 dtex | 84 dtex | 167 dtex | 55 dtex |
| along | | | | |
| thread count | 23/cm | 30/cm | 20/cm | 27/cm |
| across (weft) | | | | |
| thread weight | 167 dtex | 167 dtex | 167 dtex | 334 dtex |
| across | | | | |

TABLE 2
Adhesive tape properties of various PEF weave adhesive tapes

| | (I) | | (II) | | (III) | | (IV) | |
|---|---|---|---|---|---|---|---|---|
| type of | acrylate | | synthetic | | synthetic | | acrylate | |
| adhesive | | | rubber | | rubber | | | |
| adhesive | 95 | g/m² | 60 | g/m² | 82.5 | g/m² | 50 | g/m² |
| add-on | | | | | | | | |

| | | | | | | | |
|---|---|---|---|---|---|---|---|
| overall | 0.26 | mm | 0.16 to | 0.215 | mm | 0.19 | mm |
| thickness | | | 0.18 mm | | | | |

| | | | | |
|---|---|---|---|---|
| adherence | 5.0 to | 10 to | 8.0 to | 3.5 to |
| to steel | 7.0 N/cm | 11 N/cm | 9.0 N/cm | 5.5 N/cm |

### Nonwoven Constructions

### Example 5

textile carrier: wet-laid nonwoven
basis weight: 35 g/m²
   composition: 22 wt % of PEF, 26.5 wt % of cellulose,
51.5 wt % of binder
   pressure-sensitive adhesive: acrylate
   essential features:
dampening class B
temperature class T3 (to Ford and LV 312)
very good media resistance
very good manual tearability

### Example 6

textile carrier: spunbonded
basis weight: 34 g/m²
   composition: 100 wt % of PEF
   laminating adhesive: acrylate
   foil: 70 μm 3-layered PE foil
   pressure-sensitive adhesive: acrylate
   The PE foil consists of the following layers (from top to bottom):
LDPE 5 μm thick no carbon black, admixed with 1 wt % of antiblocking agents
LDPE 15 μm thick, containing 8 wt % of carbon black
LDPE at 5 μm without carbon black, admixed with 1 wt % of antiblocking agents essential features:
   dampening class B
temperature class T3 (to Ford and LV 312)
very good media resistance
very good manual tearability

### Example 7

textile carrier: needlefelt (needle-punched)
basis weight: 40 g/m²
   composition: 100 wt % of PEF
   pressure-sensitive adhesive: acrylate
   essential features:
dampening class C
temperature class T3 (to Ford and LV 312)
very good media resistance
good manual tearability

### Example 8

textile carrier: Maliwatt ( )
basis weight: 70 g/m²
   composition: 100 wt % of PEF
   pressure-sensitive adhesive: acrylate
   essential features:
dampening class C
temperature class T3 (to Ford and LV 312)
very good manual tearability

1. A biobased polymer based on two or more different biobased monomers derived from biomass-containing carbohydrates where at least one biobased monomer is a furan derivative of formula I, 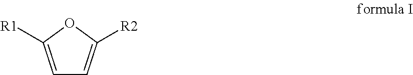
where
R1 is independently a hydrogen or an organofunctional group having 1 to 20 carbon atoms and the organofunctional group optionally comprises O, N or S atoms,
R2 is independently an organofunctional group having 1 to 20 carbon atoms which optionally comprises O, N or S atoms,
the second biobased monomer is a hydroxyl-functional compound comprising 1 to 100 carbon atoms,
wherein the polymer has an average molecular weight Mw of not less than 1000 g/mol and the proportion of biobased monomers in the biobased polymer is not less than 55 mol % relative to all monomers of the polymer.

2. The biobased polymer as claimed in claim 1,
wherein in formula I
R1 is a carboxyl group and by way of substituent comprises a linear, branched and/or cyclic substituted or unsubstituted hydrocarbyl group having 1 to 20 carbon atoms which optionally comprises O, N or S atoms, or is a carboxylic acid group, an anhydride or R1 is a hydrogen, and
R2 is a carboxyl group and by way of substituent comprises a linear, branched and/or cyclic substituted or unsubstituted hydrocarbyl group having 1 to 20 carbon atoms, or is a carboxylic acid group or an anhydride.

3. The biobased polymer as claimed in claim 1, which is a polyester obtained by reaction between the biobased monomer of formula I and the second biobased monomer, the hydroxyl-functional compound comprising a monool and/or polyol, as co-monomer.

4. The biobased polymer as claimed in claim 3, which is a polyester and the monool is selected from alcohols, aminoalcohols, monohydroxy-functional polyethers and/or the polyol is selected from diols, triols, polyether polyols comprising 1 to 100 carbon atoms, fruit acids, polyhydroxyalkanoates and/or saccharides.

5. The biobased polymer as claimed in claim 1, wherein the biobased monomer of formula I is furan-2,5-dicarboxylic acid, an anhydride, a monoester and/or a diester of furan-2,5-dicarboxylic acid and the second biobased monomer is ethylene glycol.

6. The biobased polymer as claimed in claim 1, which is a polyethylene furanoate (PEF) of formula IV as obtained from the reaction of furan-2,5-dicarboxylic acid, or of one of its ester derivatives, with ethylene glycol 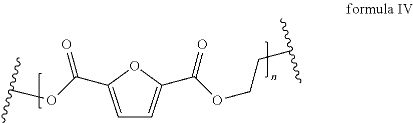
where n is not less than 2.

7. The biobased polymer as claimed in claim 1, which is a biodegradable polyester.

8. The biobased polymer as claimed in claim 1, wherein the proportion of biobased monomers of the biobased polymer is determined via the ratio of ¹⁴C/¹²C carbon atoms.

9. The biobased polymer as claimed in claim 1, wherein the polydispersity is between 1.0 and 1.9.

10. The biobased polymer as claimed in claim 1, wherein the proportion of biobased monomers in the biobased polymer is not less than 75 mol %, relative to all monomers of the polymer.

11. A process for preparing a biobased polymer as claimed in claim 1, comprising the steps of
1) converting a biobased monomer of formula I 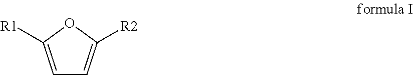
where
R1 is a carboxyl group and by way of substituent comprises a linear, branched and/or cyclic substituted or unsubstituted hydrocarbyl group having 1 to 20 carbon atoms which optionally comprises O, N or S atoms, or is a carboxylic acid group, an anhydride or a carboxylate group with a water-soluble counterion,
and independently
R2 is a carboxyl group and by way of substituent comprises a linear, branched and/or cyclic substituted or unsubstituted hydrocarbyl group having 1 to 20 carbon atoms, or is a carboxylic acid group, an anhydride or a carboxylate group with a water-soluble counterion;
2) Performing a polycondensation between the biobased monomer of formula I and the second biobased monomer, the hydroxyl-functional compound, wherein the second biobased monomer is a polyol, optionally in the presence of a condensation catalyst, whereby a biobased polymer is obtained.

12. The process as claimed in claim 11, wherein the biobased monomer of formula I is a furan-2,5-dicarboxylic acid (FDCA) derived by dehydration of sugars and specifically subsequent oxidation via the formation of prepolymers of formula III, or is a derivative thereof.

13. The process as claimed in claim 11, wherein the hydroxyl-functional compound is a biobased ethylene glycol derived in particular by 1. dehydrating bioethanol obtained from the fermentation of carbohydrates, 2. oxidizing to ethylene oxide, and 3. ring opening in the presence of water and ethanol to obtain ethylene glycol, wherein the ethanol is biobased.

14. The process as claimed in claim 11, wherein the polycondensation is carried out at a temperature of not more than 149° C.

15. An article of manufacture comprising a biobased polymer as claimed in claim 1, wherein the article of manufacture is in the form of a sheetlike element or of a fibrous structure selected from
sheetlike elements comprising spun, woven and/or molten sheetlike elements, and/or
fibrous structures comprising spun, woven and/or molten fibers.

16. material for adhesive tapes, a transfer material, a transfer foil, a release liner or a carrier material for cable wrapping tapes.

17. The method manufacturing foils and/or carrier materials, foils and/or carrier materials for adhesive tapes, cable wrapping tapes, die cuts, OLEDs, facing material, transfer material and/or release liners, comprising a step of using a polymer of claim 1.

18. A biobased carrier material comprising a biobased polymer as claimed in claim 1, which is in the form of sheetlike elements comprising spun, woven and/or molten sheetlike elements
